(19) United States
(12) Patent Application Publication
(10) Pub. No.: US 2024/0127106 A1
(43) Pub. Date: Apr. 18, 2024

(54) ONLINE AUTOMATIC HYPERPARAMETER TUNING

(71) Applicant: Roku, Inc., San Jose, CA (US)

(72) Inventors: Abhishek BAMBHA, Burlimgame, CA (US); Weicong DING, Kirkland, WA (US); Zidong WANG, San Jose, CA (US); Fei XIAO, San Jose, CA (US)

(73) Assignee: Roku, Inc., San Jose, CA (US)

(21) Appl. No.: 17/965,284

(22) Filed: Oct. 13, 2022

(51) Int. Cl. G06N 20/00

(52) U.S. Cl. CPC G06N 20/00

(57) ABSTRACT

Disclosed herein are system, apparatus, article of manufacture, method and/or computer program product embodiments, and/or combinations and sub-combinations thereof, for online automatic hyperparameter tuning of a machine learning model that provides a user experience to media devices such that the machine learning model maximizes (or minimizes) an objective function. An example embodiment operates by generating an initial set of hyperparameter configurations for a machine learning model based on sampling data received from media devices over a network. The embodiment then determines, using an hyperparameter tuning method, a hyperparameter configuration based on the initial set of hyperparameter configurations that causes a training of the machine learning model using a learning algorithm to maximize an objective function. The embodiment then trains the machine learning model according to the determined hyperparameter configuration using the learning algorithm. The embodiment then provides, using the trained machine learning model, a user experience to the media devices.

### BACKGROUND

### Field

This disclosure is generally directed to online hyperparameter tuning, and more particularly to online hyperparameter tuning to provide a user experience to remote media devices that maximizes (or minimizes) an objective function.

### Background

A machine learning model (or engineering logic) may be used to provide a user experience to different remote media devices. For example, the machine learning model may control how content recommendations are provided to the different remote media devices. The machine learning model may determine what type of user experience to provide the different remote media devices based on its model parameters.

Hyperparameters may be used to estimate or learn machine learning model parameters (or tune an engineering logic). The same kind of machine learning model (or engineering logic) can require different hyperparameter values to generalize different data patterns. Thus, the hyperparameters of the machine learning model may need to be tuned in order to discover the machine learning model parameters of the model that result in the most skillful predictions.

But there may be many (e.g., hundreds) hyperparameters that may need to be tuned in order to discover the machine learning model parameters of the model that provide an optimal user experience (e.g., maximizes or minimizes an objective function) to different remote media devices. Moreover, it is often unclear the relationship between these hyperparameters and providing a user experience that maximizes (or minimizes) some objective function. As a result, these hyperparameters are often tuned offline and fixed when the machine learning model (or engineering logic) is used in the online environment. As a result, these fixed hyperparameter combinations often produce a machine learning model (or engineering logic) that provides a suboptimal user experience to different remote media devices.

### SUMMARY

Provided herein are system, apparatus, article of manufacture, method and/or computer program product embodiments, and/or combinations and sub-combinations thereof, for online automatic hyperparameter tuning of a machine learning model (or engineering logic) that provides a user experience to media devices such that the machine learning model (or engineering logic) maximizes (or minimizes) an objective function.

An example embodiment operates by generating an initial set of hyperparameter configurations for a machine learning model based on sampling data received from media devices over a network. The initial set of hyperparameter configurations may be associated with a learning algorithm. The embodiment then determines, using an hyperparameter tuning method, a hyperparameter configuration based on the initial set of hyperparameter configurations that causes a training of the machine learning model using the learning algorithm to maximize (or minimize) an objective function. The embodiment then trains the machine learning model according to the determined hyperparameter configuration using the learning algorithm. The embodiment then provides, using the trained machine learning model, a user experience to the media devices. In this way, the embodiment can ensure with high likelihood that the trained machine learning model will provide a user experience to the media devices that will maximize (or minimize) the objective function.

### BRIEF DESCRIPTION OF THE FIGURES

The accompanying drawings are incorporated herein and form a part of the specification.

FIG. 1 illustrates a block diagram of a multimedia environment, according to some embodiments.

FIG. 2 illustrates a block diagram of a streaming media device, according to some embodiments.

FIG. 3 is a flowchart illustrating a process for providing a user experience to media devices that maximizes (or minimizes) an objective function, according to some embodiments.

FIG. 4 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for online automatic hyperparameter tuning of a machine learning model (or engineering logic) that provides a user experience to media devices such that the machine learning model maximizes (or minimizes) an objective function.

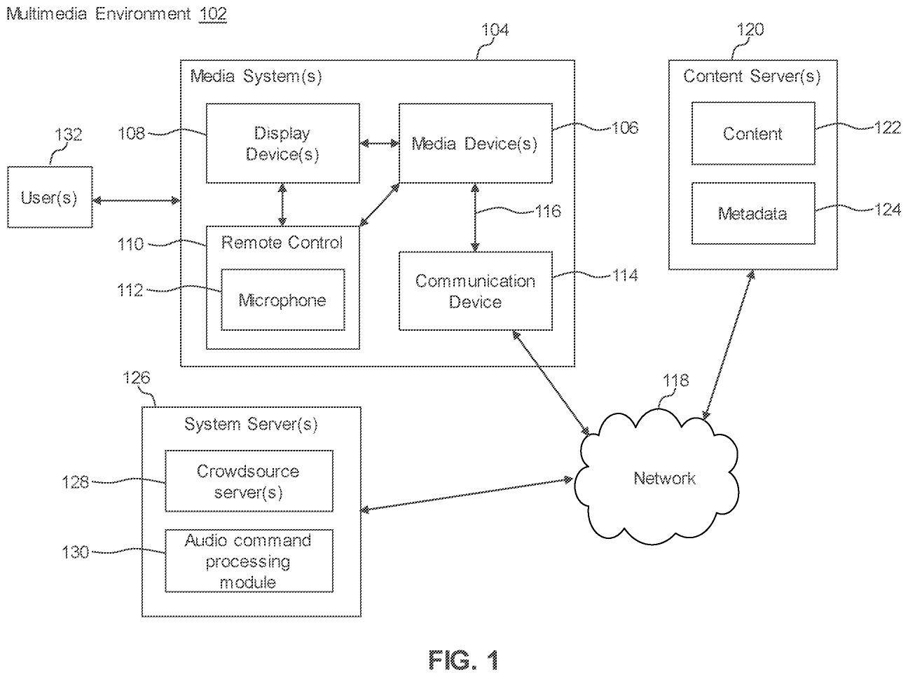

Various embodiments of this disclosure may be implemented using and/or may be part of a multimedia environment 102 shown in FIG. 1. It is noted, however, that multimedia environment 102 is provided solely for illustrative purposes, and is not limiting. Embodiments of this disclosure may be implemented using and/or may be part of environments different from and/or in addition to the multimedia environment 102, as will be appreciated by persons skilled in the relevant art(s) based on the teachings contained herein. An example of the multimedia environment 102 shall now be described.

### Multimedia Environment

FIG. 1 illustrates a block diagram of a multimedia environment 102, according to some embodiments. In a non-limiting example, multimedia environment 102 may be directed to streaming media. However, this disclosure is applicable to any type of media (instead of or in addition to streaming media), as well as any mechanism, means, protocol, method and/or process for distributing media.

The multimedia environment 102 may include one or more media systems 104. A media system 104 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. User(s) 132 may operate with the media system 104 to select and consume content.

Each media system 104 may include one or more media devices 106 each coupled to one or more display devices 108. It is noted that terms such as “coupled,” “connected to,” “attached,” “linked,” “combined” and similar terms may refer to physical, electrical, magnetic, logical, etc., connections, unless otherwise specified herein.

Media device 106 may be a streaming media device, DVD or BLU-RAY device, audio/video playback device, cable box, and/or digital video recording device, to name just a few examples. Display device 108 may be a monitor, television (TV), computer, smart phone, tablet, wearable (such as a watch or glasses), appliance, internet of things (IoT) device, and/or projector, to name just a few examples. In some embodiments, media device 106 can be a part of, integrated with, operatively coupled to, and/or connected to its respective display device 108.

Each media device 106 may be configured to communicate with network 118 via a communication device 114. The communication device 114 may include, for example, a cable modem or satellite TV transceiver. The media device 106 may communicate with the communication device 114 over a link 116, wherein the link 116 may include wireless (such as WiFi) and/or wired connections.

In various embodiments, the network 118 can include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

Media system 104 may include a remote control 110. The remote control 110 can be any component, part, apparatus and/or method for controlling the media device 106 and/or display device 108, such as a remote control, a tablet, laptop computer, smartphone, wearable, on-screen controls, integrated control buttons, audio controls, or any combination thereof, to name just a few examples. In an embodiment, the remote control 110 wirelessly communicates with the media device 106 and/or display device 108 using cellular, Bluetooth, infrared, etc., or any combination thereof. The remote control 110 may include a microphone 112, which is further described below.

The multimedia environment 102 may include a plurality of content servers 120 (also called content providers, channels or sources 120). Although only one content server 120 is shown in FIG. 1, in practice the multimedia environment 102 may include any number of content servers 120. Each content server 120 may be configured to communicate with network 118.

Each content server 120 may store content 122 and metadata 124. Content 122 may include any combination of music, videos, movies, TV programs, multimedia, images, still pictures, text, graphics, gaming applications, advertisements, programming content, public service content, government content, local community content, software, and/or any other content or data objects in electronic form.

In some embodiments, metadata 124 comprises data about content 122. For example, metadata 124 may include associated or ancillary information indicating or related to writer, director, producer, composer, artist, actor, summary, chapters, production, history, year, trailers, alternate versions, related content, applications, and/or any other information pertaining or relating to the content 122. Metadata 124 may also or alternatively include links to any such information pertaining or relating to the content 122. Metadata 124 may also or alternatively include one or more indexes of content 122, such as but not limited to a trick mode index.

The multimedia environment 102 may include one or more system servers 126. The system servers 126 may operate to support the media devices 106 from the cloud. It is noted that the structural and functional aspects of the system servers 126 may wholly or partially exist in the same or different ones of the system servers 126.

The media devices 106 may exist in thousands or millions of media systems 104. Accordingly, the media devices 106 may lend themselves to crowdsourcing embodiments and, thus, the system servers 126 may include one or more crowdsource servers 128.

For example, using information received from the media devices 106 in the thousands and millions of media systems 104, the crowdsource server(s) 128 may identify similarities and overlaps between closed captioning requests issued by different users 132 watching a particular movie. Based on such information, the crowdsource server(s) 128 may determine that turning closed captioning on may enhance users' viewing experience at particular portions of the movie (for example, when the soundtrack of the movie is difficult to hear), and turning closed captioning off may enhance users' viewing experience at other portions of the movie (for example, when displaying closed captioning obstructs critical visual aspects of the movie). Accordingly, the crowdsource server(s) 128 may operate to cause closed captioning to be automatically turned on and/or off during future streamings of the movie.

The system servers 126 may also include an audio command processing module 130. As noted above, the remote control 110 may include a microphone 112. The microphone 112 may receive audio data from users 132 (as well as other sources, such as the display device 108). In some embodiments, the media device 106 may be audio responsive, and the audio data may represent verbal commands from the user 132 to control the media device 106 as well as other components in the media system 104, such as the display device 108.

In some embodiments, the audio data received by the microphone 112 in the remote control 110 is transferred to the media device 106, which is then forwarded to the audio command processing module 130 in the system servers 126. The audio command processing module 130 may operate to process and analyze the received audio data to recognize the user 132's verbal command. The audio command processing module 130 may then forward the verbal command back to the media device 106 for processing.

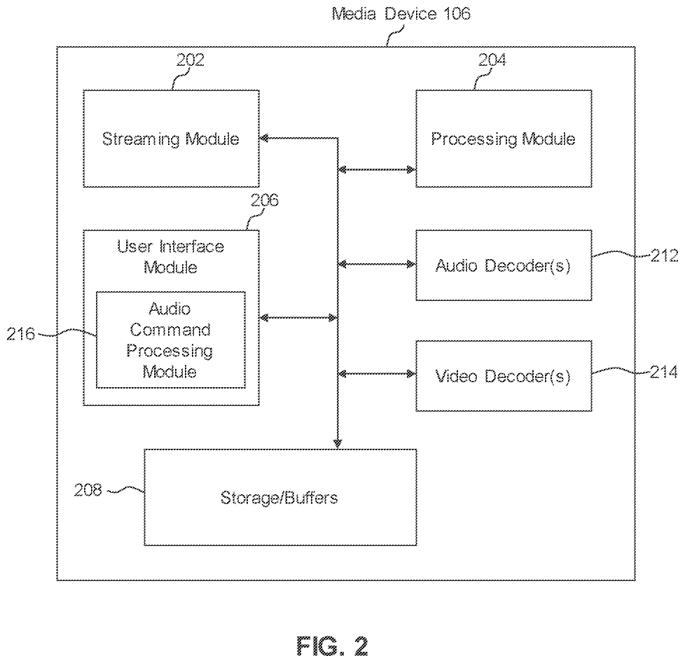

In some embodiments, the audio data may be alternatively or additionally processed and analyzed by an audio command processing module 216 in the media device 106 (see FIG. 2). The media device 106 and the system servers 126 may then cooperate to pick one of the verbal commands to process (either the verbal command recognized by the audio command processing module 130 in the system servers 126, or the verbal command recognized by the audio command processing module 216 in the media device 106).

FIG. 2 illustrates a block diagram of an example media device 106, according to some embodiments. Media device 106 may include a streaming module 202, processing module 204, storage/buffers 208, and user interface module 206. As described above, the user interface module 206 may include the audio command processing module 216.

The media device 106 may also include one or more audio decoders 212 and one or more video decoders 214.

Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to H.263, H.264, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Now referring to both FIGS. 1 and 2, in some embodiments, the user 132 may interact with the media device 106 via, for example, the remote control 110. For example, the user 132 may use the remote control 110 to interact with the user interface module 206 of the media device 106 to select content, such as a movie, TV show, music, book, application, game, etc. The streaming module 202 of the media device 106 may request the selected content from the content server(s) 120 over the network 118. The content server(s) 120 may transmit the requested content to the streaming module 202. The media device 106 may transmit the received content to the display device 108 for playback to the user 132.

In streaming embodiments, the streaming module 202 may transmit the content to the display device 108 in real time or near real time as it receives such content from the content server(s) 120. In non-streaming embodiments, the media device 106 may store the content received from content server(s) 120 in storage/buffers 208 for later playback on display device 108.

Online Automatic Hyperparameter Tuning

Referring to FIG. 1, system servers 126 may provide a user experience to media devices 106. For example, system servers 126 may control how content recommendations are provided to media devices 106. System servers 126 may also control how a user interface is displayed on media devices 106. System servers 126 may use online automatic hyperparameter tuning of a machine learning model (or engineering logic) to provide an optimal user experience to media devices 106. For example, system servers 126 may use online automatic hyperparameter tuning of a machine learning model (or engineering logic) to provide a user experience to media devices 106 that maximizes (or minimizes) an objective function (e.g., a business target such as total advertising revenue per session). While the below discussion describes an example of online automatic hyperparameter tuning of a machine learning model to provide an optimal user experience to media devices 106, it is not limited to online automatic hyperparameter tuning of a machine learning model to provide an optimal user experience to media devices 106. The described online automatic hyperparameter tuning may also be used to tune an engineering logic to provide an optimal user experience to media devices 106.

As discussed above, system servers 126 may provide a user experience to media devices 106 according to a machine learning model (or engineering logic). The machine learning model (or engineering logic) may control how a user experience is provided to media devices 106. For example, the machine learning model (or engineering logic) may control how content recommendations are provided media devices 106. The machine learning model (or engineering logic) may also control how a user interface is displayed on media devices 106.

The machine learning model may determine what type of user experience to provide media devices 106 based on its model parameters. A machine learning model parameter may be a configuration variable that is internal to the machine learning model (e.g., the weights in an artificial neural network, support vectors in a support vector machine, or coefficients in a linear regression or logistic regression). The values of machine learning model parameters can define how the model maps input data to output data (e.g., makes predictions or provides a particular user experience for a particular media device 106). The values of machine learning model parameters can be estimated or learned from data. For example, the values of machine learning model parameters can be learned by training the model using training data according to a learning algorithm.

Hyperparameters may be used to estimate machine learning model parameters (or tune an engineering logic). A hyperparameter may be a configuration variable that is external to the machine learning model and whose value can be used to control the learning process. For example, a hyperparameter may be a learning rate for training a neural network, the penalty (e.g., C) and sigma (e.g., σ) hyperparameters for support vector machines, or the k in k-nearest neighbors. The same kind of machine learning model can require different hyperparameter values to generalize different data patterns. Thus, the hyperparameters of the machine learning model may need to be tuned in order to discover the model parameters of the model that result in the most skillful predictions.

But there may be many (e.g., hundreds) hyperparameters that may need to be tuned in order to discover the machine learning model parameters of the model that provide an optimal solution for a given problem (e.g., providing a user experience to media devices 106 that maximizes (or minimizes) some objective function such as, but not limited to, maximizing advertising revenue per session). Moreover, it is often unclear the relationship between these hyperparameters and the given problem. In other words, it often unclear the best values for these hyperparameers on the given problem. As a result, these hyperparameters are often tuned offline and fixed when the machine learning model is used in the online environment (e.g., multimedia environment 102). But tuning these hyperparameters offline often often produces a machine learning model that provides a suboptimal user experience to media devices 106.

To solve these technological problems, system servers 126 may use online automatic hyperparameter tuning of a machine learning model (or engineering logic) to provide a user experience to media devices 106 that maximizes (or minimizes) an objective function. System servers 126 may generate an initial set of hyperparameter configurations for a machine learning model (or engineering logic) that provides a user experience to media devices 106. Each hyperparameter configuration may represent values for hyperparameters of the machine learning model (or engineering logic). System servers 126 may generate the initial set of hyperparameter configurations based on sampling data received from media devices 106 (e.g., over network 118). System servers 126 may also generate the initial set of hyperparameter configurations based on historical offline data associated with media devices 106. And system servers 126 may generate the initial set of hyperparameter configurations based on sampling data received from media devices 106 and historical offline data associated with media devices 106. As would be appreciated by a person of ordinary skill in the art, system servers 126 may generate the initial set of hyperparameter configurations based on various other data and/or combinations of data.

The initial set of hyperparameter configurations may be associated with a learning algorithm that can be used train the machine learning model (or tune the engineering logic). As would be appreciated by a person of ordinary skill in the art, various learning algorithms may be used to train the machine learning model (or tune the engineering logic). For example, the Upper Confidence Bound (UCB) algorithm may be used to train the machine learning model. The Thompson Sampling algorithm may also be used to train the machine learning model. And the Cross Entropy Method (CEM) may be used to train the machine learning model.

The chosen learning algorithm may define different hyperparameters for estimating or learning the model parameters for the machine learning model (or tuning the engineering logic). In other words, different learning algorithms may utilize different hyperparameters. For example, a learning algorithm may use a learning rate. For support vector machines, the hyperparameters may include the penalty (e.g., C) and/or sigma (e.g., σ) parameters. For artificial neural networks, the hyperparameters may include a number of layers and/or a number of neurons per layer. For a k-means clustering algorithm, the hyperparameters may include the number of clusters.

After generating the initial set of hyperparameter configurations, system servers 126 may determine, using a hyperparameter tuning method, a hyperparameter configuration that causes a training of the machine learning model (or tuning of the engineering logic) using a learning algorithm to maximize (or minimize) an objective function. For example, system servers 126 may determine, using a hyperparameter tuning method, a hyperparameter configuration that causes a training of the machine learning model using its associated learning algorithm such that it provides a user experience to media devices 106 that maximizes (or minimizes) an objective function. System servers 126 may determine the hyperparameter configuration based on the initial set of hyperparameter configurations.

System servers 126 may determine the hyperparameter configuration using various hyperparameter tuning methods as would be appreciated by a person of ordinary skill in the art. For example, system servers 126 may determine the hyperparameter configuration using a grid search algorithm. System servers 126 may also determine the hyperparameter configuration using a random search algorithm. System servers 126 may also determine the hyperparameter configuration using a Bayesian optimization algorithm. System servers 126 may also determine the hyperparameter configuration using a gradient-based optimization algorithm. System servers 126 may also determine the hyperparameter configuration using an evolutionary optimization algorithm. System servers 126 may also determine the hyperparameter configuration using a population-based training algorithm. And system servers 126 may determine the hyperparameter configuration using an early-stopping-based algorithm.

System servers 126 may determine, using the hyperparameter turning method, the hyperparameter configuration that causes a training of the machine learning model (or tuning of the engineering logic) using its associated learning algorithm such that it provides a user experience to media devices 106 that maximizes (or minimizes) an objective function. System servers 126 may attempt to maximize (or minimize) various objective functions. System servers 126 may attempt to maximize (or minimize) an objective function that is based on a business target. For example, system servers 126 may attempt to maximize (or minimize) the total advertisement revenue per session. System servers 126 may also attempt to maximize (or minimize) an objective function that is based on other targets such as, but not limited to, computational efficiency, computer memory utilization, and/or power efficiency.

After determining the hyperparameter configuration, system servers 126 can train the machine learning model (or tune the engineering logic) according to the determined hyperparameter configuration using its associated learning algorithm. System servers 126 can then use the trained machine learning model to provide a user experience to media devices 106. For example, system servers 126 can use the trained machine learning model to provide an optimial user interface to media devices 106. System server 126 can also use the trained machine learning model to provide optimal content recommendations to media devices 106. Because the machine learning model was trained according to a hyperparameter configuration determined from online data from media devices 106 to maximize (or minimize) an objective function, system servers 126 can ensure with high likelihood that using this trained machine learning model to provide a user experience to media devices 106 will maximize (or minimize) the objective function (e.g., total advertisement revenue per session).

To further improve the providing of a user experience to media devices 106 that will maximize (or minimize) the objective function (e.g., total advertisement revenue per session), system servers 126 can periodically repeat the above process. In other words, system servers 126 can repeatedly: generate an initial set of hyperparameter configurations based on sampling data received from media devices 106, determine a hyperparameter configuration based on the initial set of hyperparameter configurations that causes a training of the machine learning model (or a tuning of an engineering logic) such that maximizes (or minimizes) the objective function, train the machine learning model (or tune the engineering logic) using the determined hyperparameter configuration, and provide, using the trained machine learning model (or tuned engineering logic), an updated user experience to media devices 106. System servers 126 can periodically repeat this process according to a schedule. For example, system servers 126 can repeat this process every hour, day, or week. The schedule may be based on various characteristics of the media devices 106, the users operating media devices 106, or both. The schedule may be based on various other characteristics as would be appreciated by a person of ordinary skill in the art.

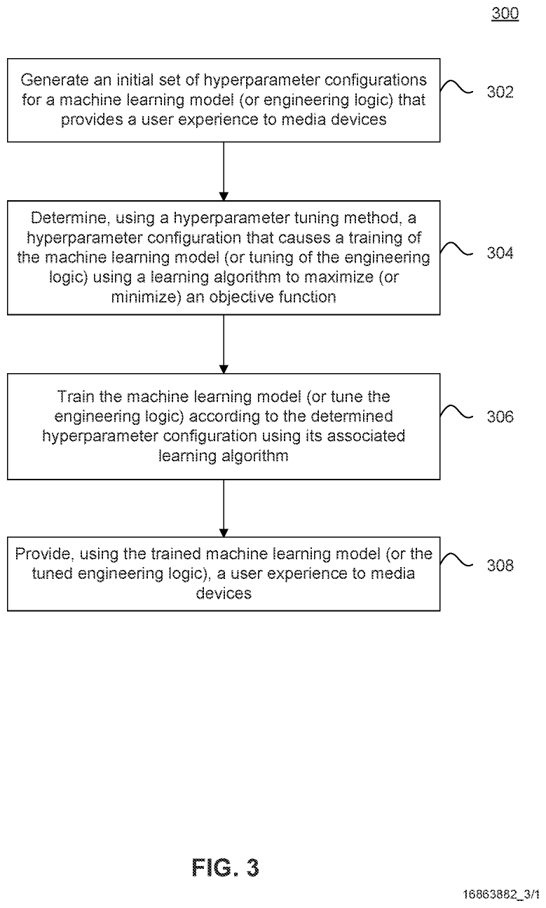

FIG. 3 is a flowchart for a method 300 for providing a user experience to media devices that maximizes (or minimizes) an objective function, according to an embodiment. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art.

Method 300 shall be described with reference to FIG. 1. However, method 300 is not limited to that example embodiment.

In step 302, system server 126 generates an initial set of hyperparameter configurations for a machine learning model (or engineering logic) that provides a user experience to media devices 106. System server 126 may generate the initial set of hyperparameter configurations based on sampling data received from media devices 106 (e.g., over network 118). System servers 126 may also generate the initial set of hyperparameter configurations based on historical offline data associated with media devices 106. And system servers 126 may generate the initial set of hyperparameter configurations based on sampling data received from media devices 106 and historical offline data associated with media devices 106. As would be appreciated by a person of ordinary skill in the art, system servers 126 may generate the initial set of hyperparameter configurations based on various other data and/or combinations of data.

The initial set of hyperparameter configurations may be associated with a learning algorithm that can be used train the machine learning model (or tune the engineering logic). As would be appreciated by a person of ordinary skill in the art, various learning algorithms may be used to train the machine learning model (or tune the engineering logic). For example, the UCB algorithm may be used to train the machine learning model. The Thompson Sampling algorithm may also be used to train the machine learning model. And the CEM may be used to train the machine learning model.

In 304, system server 126 determines, using a hyperparameter tuning method, a hyperparameter configuration that causes a training of the machine learning model (or tuning of the engineering logic) using a learning algorithm to maximize (or minimize) an objective function. For example, system server 126 may determine, using the hyperparameter tuning method, the hyperparameter configuration that causes a training of the machine learning model using its associated learning algorithm such that it provides a user experience to media devices 106 that maximizes (or minimizes) the objective function. System servers 126 may determine the hyperparameter configuration based on the initial set of hyperparameter configurations.

System servers 126 may determine the hyperparameter configuration using various hyperparameter tuning methods as would be appreciated by a person of ordinary skill in the art. For example, system servers 126 may determine the hyperparameter configuration using a grid search algorithm. System servers 126 may also determine the hyperparameter configuration using a random search algorithm. System servers 126 may also determine the hyperparameter configuration using a Bayesian optimization algorithm. System servers 126 may also determine the hyperparameter configuration using a gradient-based optimization algorithm. System servers 126 may also determine the hyperparameter configuration using an evolutionary optimization algorithm. System servers 126 may also determine the hyperparameter configuration using a population-based training algorithm. And system servers 126 may determine the hyperparameter configuration using an early-stopping-based algorithm.

System servers 126 may determine, using the hyperparameter turning method, the hyperparameter configuration that causes a training of the machine learning model (or tuning of the engineering logic) using its associated learning algorithm such that it provides a user experience to media devices 106 that maximizes (or minimizes) an objective function. System servers 126 may attempt to maximize (or minimize) various objective functions. System servers 126 may attempt to maximize (or minimize) an objective function that is based on a business target. For example, system servers 126 may attempt to maximize (or minimize) the total advertisement revenue per session. System servers 126 may also attempt to maximize (or minimize) an objective function that is based on other targets such as, but not limited to, computational efficiency, computer memory utilization, and/or power efficiency.

In 306, system server 126 trains the machine learning model (or tunes the engineering logic) according to the determined hyperparameter configuration using its associated learning algorithm.

In 308, system server 126 provides, using the trained machine learning model (or tuned the engineering logic), a user experience to media devices 106. In other words, system server 126 provides, using the trained machine learning model, a user experience to media devices 106 that maximizes (or minimizes) the objective function.

To further improve the providing of a user experience to media devices 106 that will maximize (or minimize) the objective function (e.g., total advertisement revenue per session), system server 126 can periodically repeat method 300. System server 126 can repeat method 300 according to a schedule. For example, system server 126 can repeat method 300 every hour, day, or week. The schedule may be based on various characteristics of the media devices 106, the users operating media devices 106, or both. The schedule may be based on various other characteristics as would be appreciated by a person of ordinary skill in the art.

### Example Computer System

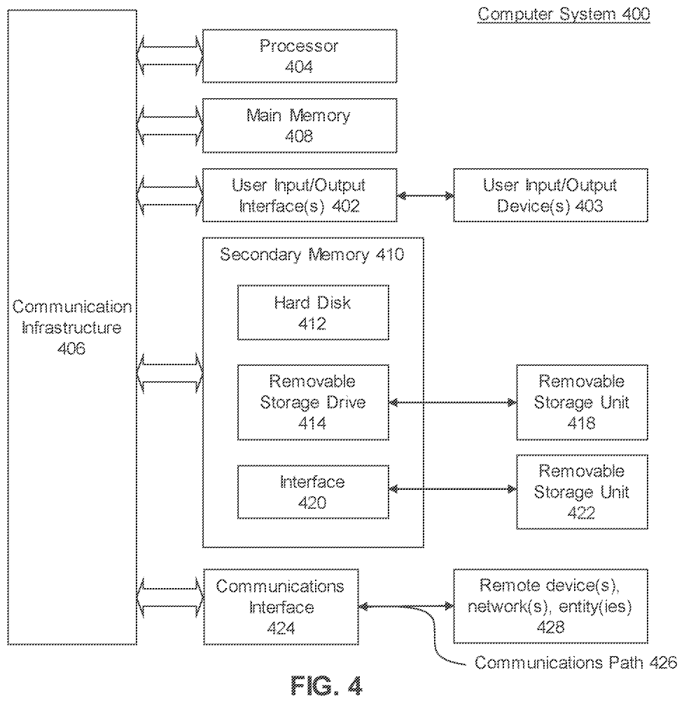

Various embodiments may be implemented, for example, using one or more well-known computer systems, such as computer system 400 shown in FIG. 4. For example, the media device 106 may be implemented using combinations or sub-combinations of computer system 400. Also or alternatively, one or more computer systems 400 may be used, for example, to implement any of the embodiments discussed herein, as well as combinations and sub-combinations thereof.

Computer system 400 may include one or more processors (also called central processing units, or CPUs), such as a processor 404. Processor 404 may be connected to a communication infrastructure or bus 406.

Computer system 400 may also include user input/output device(s) 403, such as monitors, keyboards, pointing devices, etc., which may communicate with communication infrastructure 406 through user input/output interface(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400 or processor(s) 404), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described herein.

### CONCLUSION

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for providing a user experience to media devices that maximizes an objective function, comprising:
generating, by at least one computer processor, an initial set of hyperparameter configurations for a machine learning model based on sampling data received from media devices over a network, wherein the initial set of hyperparameter configurations is associated with a learning algorithm;
determining, using a hyperparameter tuning method, a hyperparameter configuration based on the initial set of hyperparameter configurations that causes a training of the machine learning model using the learning algorithm to maximize an objective function;
training the machine learning model according to the hyperparameter configuration using the learning algorithm; and
providing, using the trained machine learning model, a user experience to the media devices.

2. The computer implemented method of claim 1, wherein the learning algorithm comprises at least one of an Upper Confidence Bound (UCB) algorithm, a Thompson sampling algorithm, or a cross entropy method (CEM) algorithm.

3. The computer implemented method of claim 1, wherein the hyperparameter tuning method comprises a grid search algorithm, a random search algorithm, a Bayesian optimization algorithm, a gradient-based optimization algorithm, an evolutionary optimization algorithm, a population-based training algorithm, or an early stopping-based algorithm.

4. The computer implemented method of claim 1, wherein the objective function is based on one of a business target, a computational efficiency target, a computer memory utilization target, or a power efficiency target.

5. The computer implemented method of claim 1, wherein the generating, the determining, the training, and the providing are repeated according to a schedule.

6. The computer implemented method of claim 1, wherein the providing, using the trained machine learning model, the user experience to the media devices comprises:
providing, using the trained machine learning model, a user interface to the media devices.

7. The computer implemented method of claim 1, wherein the generating the set of hyperparameter configurations for the machine learning model comprises:
generating the set of hyperparameter configurations for the machine learning model based on historical offline data.

8. A system, comprising:
one or more memories; and
at least one processor each coupled to at least one of the memories and configured to perform operations comprising:
generating an initial set of hyperparameter configurations for a machine learning model based on sampling data received from media devices over a network, wherein the initial set of hyperparameter configurations is associated with a learning algorithm;
determining, using a hyperparameter tuning method, a hyperparameter configuration based on the initial set of hyperparameter configurations that causes a training of the machine learning model using the learning algorithm to maximize an objective function;
training the machine learning model according to the hyperparameter configuration using the learning algorithm; and
providing, using the trained machine learning model, a user experience to the media devices.

9. The system of claim 8, wherein the learning algorithm comprises at least one of an Upper Confidence Bound (UCB) algorithm, a Thompson sampling algorithm, or a cross entropy method (CEM) algorithm.

10. The system of claim 8, wherein the hyperparameter tuning method comprises a grid search algorithm, a random search algorithm, a Bayesian optimization algorithm, a gradient-based optimization algorithm, an evolutionary optimization algorithm, a population-based training algorithm, or an early stopping-based algorithm.

11. The system of claim 8, wherein the objective function is based on one of a business target, a computational efficiency target, a computer memory utilization target, or a power efficiency target.

12. The system of claim 8, wherein the providing, using the trained machine learning model, the user experience to the media devices comprises:
providing, using the trained machine learning model, a user interface to the media devices.

13. The system of claim 8, wherein the generating the set of hyperparameter configurations for the machine learning model comprises:
generating the set of hyperparameter configurations for the machine learning model based on historical offline data.

14. A non-transitory computer-readable medium having instructions stored thereon that, when executed by at least one computing device, cause the at least one computing device to perform operations comprising:
generating an initial set of hyperparameter configurations for a machine learning model from sampling data received from media devices over a network, wherein the initial set of hyperparameter configurations is associated with a learning algorithm;
determining, using a hyperparameter tuning method, a hyperparameter configuration based on the initial set of hyperparameter configurations that causes a training of the machine learning model using the learning algorithm to maximize an objective function;
training the machine learning model according to the determined hyperparameter configuration using the learning algorithm; and
providing, using the trained machine learning model, a user experience to the media devices.

15. The non-transitory computer readable medium of claim 14, wherein the learning algorithm comprises at least one of an Upper Confidence Bound (UCB) algorithm, a Thompson sampling algorithm, or a cross entropy method (CEM) algorithm.

16. The non-transitory computer readable medium of claim 14, wherein the hyperparameter tuning method comprises a grid search algorithm, a random search algorithm, a Bayesian optimization algorithm, a gradient-based optimization algorithm, an evolutionary optimization algorithm, a population-based training algorithm, or an early stopping-based algorithm.

17. The non-transitory computer readable medium of claim 14, wherein the objective function is based on one of a business target, a computational efficiency target, a computer memory utilization target, or a power efficiency target.

18. The non-transitory computer readable medium of claim 14, wherein the generating, the determining, the training, and the providing are repeated according to a schedule.

19. The non-transitory computer readable medium of claim 14, wherein the providing, using the trained machine learning model, the user experience to the media devices comprises:
providing, using the trained machine learning model, a user interface to the media devices.

20. The non-transitory computer readable medium of claim 14, wherein the generating the set of hyperparameter configurations for the machine learning model comprises:
generating the set of hyperparameter configurations for the machine learning model based on historical offline data.
